(19) United States
(12) Patent Application Publication
(10) Pub. No.: US 2014/0261973 A1
(43) Pub. Date: Sep. 18, 2014

(54) METHODS FOR RETREADING TIRES EMPLOYING TREAD COMPOSITES MADE WITH DRY-TRANSFER CEMENT COMPOSITE

(71) Applicant: Bridgestone Bandag, LLC, Muscatine, IA (US)

(72) Inventor: David L. Bender, Muscatine, IA (US)

(21) Appl. No.: 14/211,748

(22) Filed: Mar. 14, 2014

Related U.S. Application Data
(60) Provisional application No. 61/798,193, filed on Mar. 15, 2013.

(51) Int. Cl. B29D 30/54

(52) U.S. Cl. CPC B29D 30/54
USPC 156/96; 427/207.1; 428/41.8

(57) ABSTRACT

A process for retreading a tire, the process comprising the steps of providing a liquid rubber cement composition including a solvent, providing a release liner, applying the liquid cement composition to the release liner to form a wet film on said release liner, allowing the solvent to evaporate to thereby convert the wet film to a dried film on the release liner and thereby form a dry-transfer cement composite, providing a cured rubber component having first and second planar surfaces, where the first planar surface includes a tread pattern, adhering the dried film to the second planar surface of the cured rubber component to thereby form a tread composite, and preparing a retreaded tire using the tread composite.

### FIELD OF THE INVENTION

Embodiments of the invention relate to methods for producing tread composites that are useful in retreading a tire. According to one or more embodiments, the tread composites are prepared by employing a dry-transfer cement composite.

### BACKGROUND OF THE INVENTION

Retreaded tires have been available for many years and provide an economical way to gain additional use out of a tire casing after the original tread has become worn. As is known in the art, the process generally begins with removal of the remaining tread from the tire casing. This can be accomplished by a buffing machine that grinds away the old tread and leaves a buffed surface that is generally smooth about the circumference of the tire casing. The tire casing may then be examined for injuries and repaired.

After completion of the repairs, the buffed surface can receive a new tread. In one process, the new tread, which is cured prior to applying the tread to the casing, is secured to the casing through a layer often referred to as a cushion gum or cushion gum layer. This cushion gum is an uncured rubber-containing composition that, upon curing, mates the new tread to the casing.

In some processes, the cushion gum is applied to the back, i.e., the inside surface, of a new tread. The cushion gum and tread can then be applied in combination about the circumference of the tire casing to create an uncured retreaded tire assembly that is ready for curing. The uncured retreaded tire assembly is then placed within a flexible rubber envelope and an airtight seal is created between the envelope and the beads of the tire. The entire enveloped tire assembly is placed within a curing chamber and subjected to pressure and heat in order to effect curing of the cushion gum.

Logistically, the tread is typically manufactured at a tread-making facility and shipped to a retreading facility where the new tread is applied to the casing. The cushion gum is likewise generally made a facility distinct from the retreading facility; e.g. it can be prepared at a tread-making facility and shipped to the retreading facility.

In many processes, the tread is produced as a composite tread assembly where the back of the tread is coated with a rubber cement composition. After evaporation of the solvents within the cement, a dried layer of rubber cement is formed on the back surface of the tread treated with the cement. This cement layer is then covered by application of a protective film or paper to form the composite tread assembly. This assembly is then shipped to the retreading facility where the composite can be mated with the cushion gum by removing the protective film and mating the cushion gum with the surface of the tread that carries the rubber cement layer.

U.S. Pat. No. 4,075,047 teaches a more elaborate composite tread assembly where the cushion gum is applied to the tread within the tread-making facility. A protective film or paper can then be applied to the side of the cushion gum opposite where the gum is mated to the tread or cement layer. In other words, the composite includes a tread layer, a cement layer applied to the back of the tread, a cushion gum applied to the cement layer, and a protective film or paper applied to the cushion gum.

The skilled person understands that several distinctions exist between the cement layer and the cushion gum. For example, the cement layer is appreciably thinner than the gum layer. And, the respective layers are compositionally distinct since each layer serves a different purpose in the overall formation of a retreaded tire. For example, the gum layer often includes significantly more curative than the cement.

Due to the distinctions between the cushion gum and the cement layer, each component often has a different shelf life. Typically, the shelf life of the gum cushion is much shorter than the shelf life of the tread composite that only includes the tread and the cement layer; months versus years. Thus, the shelf life of a composite that includes both a gum cushion and a cement layer is limited by the shelf life of the cushion gum. It is therefore sometimes desirable to produce composites that include the cement layer only and separately produce and provide to the retreading facility the gum cushion.

The production of the tread composite is also challenging due to the presence of solvents with the rubber cement composition. Since many rubber cement compositions include volatile organic compounds, the ability to use and manage these cement compositions, especially within a tread-manufacturing facility, is an ever increasing challenge.

A desire therefore exists to improve upon the manufacture of the tread composite, especially as the process relates to the use and management of the rubber cement.

### SUMMARY OF THE INVENTION

One or more embodiments of the present invention provide a process for retreading a tire, the process comprising the steps of providing a liquid rubber cement composition including a solvent, providing a release liner, applying the liquid cement composition to the release liner to form a wet film on said release liner, allowing the solvent to evaporate to thereby convert the wet film to a dried film on the release liner and thereby form a dry-transfer cement composite, providing a cured rubber component having first and second planar surfaces, where the first planar surface includes a tread pattern, adhering the dried film to the second planar surface of the cured rubber component to thereby form a tread composite, and preparing a retreaded tire using the tread composite.

One or more embodiments of the present invention further provide a process for producing a dry-transfer cement adapted for application to the backside of a cured tread, the process comprising the steps of providing a liquid rubber cement composition including a solvent, providing a release liner, applying the liquid cement composition to the release liner to form a wet film on said release liner, and allowing the solvent to evaporate to thereby convert the wet film to a dried film on the release liner and thereby form a dry-transfer cement composite.

One or more embodiments of the present invention further provide a process for producing a tread composite adapted for use in retreading a tire, the process comprising the steps of providing a liquid rubber cement composition including a solvent, providing a release liner, applying the liquid cement composition to the release liner to form a wet film on said release liner, allowing the solvent to evaporate to thereby convert the wet film to a dried film on the release liner and thereby form a dry-transfer cement composite, providing a cured rubber component having first and second planar surfaces, where the first planar surface includes a tread pattern, and adhering the dried film to the second planar surface of the cured rubber component to thereby form a tread composite.

One or more embodiments of the present invention further provide a dry-transfer cement composite comprising a first layer including a pressure sensitive adhesive composition including a rubber, a tackifier, and a curative, based upon the entire weight of the adhesive composition, and a release liner removably adhered to the first layer.

### BRIEF DESCRIPTION OF THE DRAWINGS

FIG. 1 is a perspective bottom view of a tread composite prepared according to one or more embodiments of the invention.

FIG. 2 is a perspective top view of a tread composite prepared according to one or more embodiments of the invention.

### DETAILED DESCRIPTION OF ILLUSTRATIVE EMBODIMENTS

Embodiments of the present invention are based, at least in part, upon the discovery of a method for forming a tread composite that includes a cured rubber component, a rubber cement layer, and a release layer over the rubber cement layer. According to embodiments of this invention, a dried rubber cement layer is prepared in advance of its application to the tread. As described in greater detail herein, a dried layer can be produced by applying a liquid rubber cement composition to a release film to form a pressure sensitive tape, the combination of which may also be referred to as a dry-transfer cement composite. This tape can then be applied to the back of a tread to form a tread composite. Advantageously, this technique substantially eliminates the need for solvent evaporation after application of the cement to the tread. Moreover, the process allows for efficient production of the tape in facilities other then the tread-manufacturing facility, and therefore the tape can be produced in locations equipped to better manage solvent evaporation such as facilities that are able recapture and reuse solvents.

### Dry-Transfer Cement Composite

As noted above, rubber cement layer is produced. This rubber cement layer may also be referred to as a pressure sensitive adhesive, a dry-transfer cement composite, a rubber cement layer, or simply as a tape or adhesive. This tape is adapted for use as a cement layer in a tread composite. As a result, the tape has compositional and physical characteristics indicative of a cement layer. The skilled person will appreciate that one or more of these characteristics serve to distinguish the cement layer from other adhesive layers employed in the retreading process such as the cushion gum layer.

In one or more embodiments, the tape is produced by applying a liquid cement composition to a protective layer to form a wet film of the cement composition on the protective layer. Solvents within the wet film are allowed to evaporate to thereby form a dried film on the protective layer. This laminate, which is in the form of a pressure-sensitive tape, can then be rolled, stored, and/or transported. In certain embodiments, the tape is produced at a facility that is distinct from the tread-manufacturing facility, and therefore transportation of the tape includes shipping the tape to a tread-manufacturing facility. In one or more advantageous embodiments, the tape is manufactured at a facility equipped to capture and reuse the solvents that are evaporated.

### Liquid Rubber Cement Composition

Practice of one or more embodiments of the present invention is not necessarily limited by the selection of any particular liquid cement composition. Accordingly, liquid cement compositions known in the art may be used in the practice of this invention. In this regard, U.S. Pat. Nos. 3,335,041, 3,421,565, 3,342,238, 3,514,423, 4,463,120, 4,539,365, and 8,143,338, which teach liquid cement compositions, are incorporated herein by reference.

In one or more embodiments, the liquid cement composition is a solution or dispersion that includes a rubber, a tackifier resin, a curative, and a solvent. In these or other embodiments, the liquid cement composition may include other constituents commonly employed in compositions of this nature including, but not limited to, fillers, zinc oxide, antioxidants, stearic acid, cure accelerators, cure retarders, waxes, and oils.

In one or more embodiments, the rubber may include natural or synthetic crosslinkable polymers that, upon curing, have elastomeric properties. These polymers include, but are not limited to, natural rubber, synthetic polyisoprene, polybutadiene, polyisobutylene-co-isoprene, poly(chloroprene), poly(ethylene-co-propylene), poly(styrene-co-butadiene), poly(styrene-co-isoprene), and poly(styrene-co-isoprene-co-butadiene), poly(isoprene-co-butadiene), poly(ethylene-co-propylene-co-diene), polysulfide rubber, acrylic rubber, urethane rubber, silicone rubber, and epichlorohydrin rubber. In one or more embodiments, blends of one or more of the foregoing rubbers may be employed. In particular embodiments, the blend may include natural rubber and synthetic rubber.

In one or more embodiments, the tackifier resin may include a phenolic resin. In these or other embodiments, the tackifier resin may include a hydrocarbon resin. In one or more embodiments, phenolic resins include phenol-formaldehyde resins. For example, the phenolic resins may include novolac resins, which are phenol-formaldehyde resins where the molar ratio of the formaldehyde to phenol is less than one. These resins are typically synthesized by using an acid catalyst. Other useful phenolic resins include resole resins wherein the molar ratio of the formaldehyde to phenol is greater than one during synthesis. These resins are typically synthesized by using a base catalyst. In one or more embodiments, these resins may be preformed, and in other embodiments that may be formed in situ.

In one or more embodiments, hydrocarbon resins may include natural resins, synthetic resins, and low molecular weight polymers or oligomers. The monomer that may be polymerized to synthesize the synthetic resins or low molecular weight polymers or oligomers may include those obtained from refinery streams containing mixtures or various unsaturated materials or from pure monomer feeds. The monomer may include aliphatic monomer, cycloaliphatic monomer, aromatic monomer, or mixtures thereof. Aliphatic monomer can include C₄, C₅, and C₆ paraffins, olefins, and conjugated diolefins. Examples of aliphatic monomer or cycloaliphatic monomer include butadiene, isobutylene, 1,3-pentadiene (piperylene) along with 1,4-pentadiene, cyclopentane, 1-pentene, 2-pentene, 2-methyl-1-pentene, 2-methyl-2-butene, 2-methyl-2-pentene, isoprene, cyclohexane, 1-3-hexadiene, 1-4-hexadiene, cyclopentadiene, and dicyclopentadiene. Aromatic monomer can include C₈, C₉, and C₁₀ aromatic monomer. Examples of aromatic monomer include styrene, indene, derivatives of styrene, derivatives of indene, and combinations thereof. Examples of natural resins include rosin derivatives, terpene resins, and terpene-phenol resins.

In one or more embodiments, examples of hydrocarbon resins include aliphatic hydrocarbon resins, at least partially hydrogenated aliphatic hydrocarbon resins, aliphatic/aromatic hydrocarbon resins, at least partially hydrogenated aliphatic aromatic hydrocarbon resins, cycloaliphatic hydrocarbon resins, at least partially hydrogenated cycloaliphatic resins, cycloaliphatic/aromatic hydrocarbon resins, at least partially hydrogenated cycloaliphatic/aromatic hydrocarbon resins, at least partially hydrogenated aromatic hydrocarbon resins, polyterpene resins, terpene-phenol resins, rosin esters, and mixtures of two or more thereof. In particular embodiments, Koresin (BASF), which is believed to be phenol, 4-(1,1-dimethylethyl)-, polymer with ethyne, may be employed.

In one or more embodiments, useful solvents include those organic compounds that will not react with other constituents within the liquid cement; in other words, these compounds are inert within the composition. In one or more embodiments, these organic species are liquid at ambient temperature and pressure. Exemplary organic solvents include hydrocarbons with a low or relatively low boiling point such as aromatic hydrocarbons, aliphatic hydrocarbons, and cycloaliphatic hydrocarbons. Non-limiting examples of aromatic hydrocarbons include benzene, toluene, xylenes, ethylbenzene, diethylbenzene, and mesitylene. Non-limiting examples of aliphatic hydrocarbons include n-pentane, n-hexane, n-heptane, n-octane, n-nonane, n-decane, isopentane, isohexanes, isopentanes, isooctanes, 2,2-dimethylbutane, petroleum ether, kerosene, and petroleum spirits. And, non-limiting examples of cycloaliphatic hydrocarbons include cyclopentane, cyclohexane, methylcyclopentane, and methylcyclohexane. As is known in the art, aliphatic and cycloaliphatic hydrocarbons may be desirably employed for environmental reasons. Examples of aromatic hydrocarbon solvents include benzene, toluene, xylenes, ethylbenzene, diethylbenzene, and mesitylene, and mixtures thereof. Examples of polar solvents include as tetrahydrofurane (THF), tetrahydropyran, diglyme, 1,2-dimethoxyethene, 1,6-dimethoxyhexane, 1,3-dioxane, 1,4-dioxane, anisole, ethoxybenzene, and mixtures thereof. Mixtures of the above hydrocarbons may also be used. Other examples of organic solvents include high-boiling hydrocarbons of high molecular weights, including hydrocarbon oils that are commonly used to oil-extend polymers. Examples of these oils include paraffinic oils, aromatic oils, naphthenic oils, vegetable oils other than castor oils, citrus oils, and low PCA oils including MES, TDAE, SRAE, heavy naphthenic oils. In one or more embodiments, the solvent may include water.

In one or more embodiments, the curative includes sulfur or peroxide-based curing systems. Curing agents are described in 20 Kirk-Othmer, Encyclopedia of Chemical Technology, 365-468, (3.sup.rd Ed. 1982), particularly Vulcanization Agents and Auxiliary Materials, 390-402, and A. Y. Coran, Vulcanization in Encyclopedia of Polymer Science and Engineering, (2.sup.nd Ed. 1989), which are incorporated herein by reference. Vulcanizing agents may be used alone or in combination.

In one or more embodiments, useful fillers include carbon blacks such as those that may have a surface area (EMSA) of at least 20 m²/g and in other embodiments at least 35 m²/g; surface area values can be determined by ASTM D-1765 using the cetyltrimethylammonium bromide (CTAB) technique. The carbon blacks may be in a pelletized form or an unpelletized flocculent form. The preferred form of carbon black may depend upon the type of mixing equipment used to mix the rubber compound.

As discussed above, the cement composition may be characterized as a liquid, which may include a solution, suspension, emulsion, or dispersion of solid constituents (e.g. rubber) within the solvent.

In one or more embodiments, the liquid cement composition is substantially devoid of cure accelerators, where substantially devoid refers to that amount or less of cure accelerator that will not have an appreciable impact on the practice of this invention, which includes having a deleterious impact on the shelf life of the tread composite. In one or more embodiments, the liquid cement composition is devoid of cure accelerators.

In one or more embodiments, the liquid cement composition includes a curative. The skilled person will be able to readily select a useful level of curative by taking into account known factors impacting the amount of curative employed including, but not limited to, the rubber employed.

### Protective Layer

In one or more embodiments, the protective layer, which may also be referred to as a release backing or release liner, includes a polymeric film or a coated paper liner. In one or more embodiments, useful polymeric films include thermoplastic extrudates such as high-density polyethylene, medium-density polyethylene, low-density polyethylene, polystyrene or high-impact polystyrene, polypropylene, cellophane, and polyester extrudate films. In one or more embodiments, the film is a multi-layered film wherein the respective layers may have the same or distinct compositions. In other embodiments, the protective layer is a cellulosic substrate coated with a polymeric film or release agent such as fluoropolymer or polysiloxane coating.

### Application of Cement to Protective Layer

As described above, the liquid rubber cement is applied to the surface of the release liner. Embodiments of the present invention are not necessarily limited by the method employed to apply the liquid rubber cement to the liner. Accordingly, coating methods known in the art may be employed in practicing the present invention. For example, the cement may be applied by brush application, extrusion, spray application, calendaring, roll application, and/or knife coating. As one skilled in the art would appreciate, the coating levels and techniques are varied to optimize formation of a continuous or non-continuous layer of liquid cement onto the release liner to produce a wet film thereon.

Once the wet film is formed on the release liner, the solvent present within the cement is allowed to evaporate to thereby form dried film on the release paper. The combination of dried film and release paper may be rolled after formation of the dried film.

As discussed above, the application of the liquid rubber cement to the release liner advantageously may take place in a facility equipped to manage the release of solvents such as those including volatile organic compounds. In particular embodiments, the evaporated solvents are captured and recycled for future use.

As the skilled person will appreciate, the dried film of the rubber cement is temporarily bonded to the release liner. The affinity of the dried cement to the tread is greater than the affinity of the dried film to the release liner, which thereby allows for transfer of the dry cement to the tread. For example, when uncoiling a rolled tape, the dried film layer advantageously releases first from the backside of the release liner rather than from the first release surface. Thus, it is desirable for the backing to be releasable from the dried film layer.

Where the dry-transfer cement composite is prepared at a facility or location that is distinct from the tread-manufacturing facility, the dry-transfer cement composite can be stored and/or shipped to a tread-manufacturing facility in the form of a roll or other desirable configuration.

### Application of Dry-Transfer Cement Composite to Tread

Application of the dry-transfer cement composite to a tread can first be described with reference to the figures. As shown in FIGS. 1 and 2, composite tread 12 includes cured tread 14, which includes planar surface 16, which may also be referred to as back surface 16 or inner surface 16 of tread 14. Opposite back surface 16 is exterior surface 18, which may also be referred to as lug side 18. Consistent with known technology, exterior surface 18 includes a plurality of lugs 20 positioned between shoulders 22 and 22′.

As also shown in FIGS. 1 and 2, composite tread 12 also include dry-transfer cement composite 30, which includes dried rubber cement film 32 and release liner 34. Dried rubber cement film 32 includes a first planar surface (not shown) adhered to back surface 16 of tread 14, and a second planar surface 36 opposite to first planar surface. Release liner 34 is removably secured to second planar surface 36.

The tread composite 12 is manufactured in long lengths, for example 30 foot lengths, and may be produced in advance—within a tread-manufacturing facility—and then shipped and/or distributed to retreading facilities for use. The manufacturing process to produce the tread composite generally includes providing a cured tread and applying the dry-transfer cement composite to the cured tread.

In one or more embodiments, the back planar surface of the cured tread may optionally be buffed or otherwise mechanically treated prior to mating the back surface 16 of the tread to the first planar surface of cement film 32. This process may advantageously clean the surface of any contaminants and roughen the surface and thereby improve adhesion to the rubber cement.

In one or more embodiments, the step of buffing the back of the tread results in heating the tread prior to receiving the dry-transfer cement. In one or more embodiments, the tread is heated to a surface temperature of at least 50 C, in other embodiments at least 75 C, and in other embodiments at least 85 C.

In one or more embodiments, the back planar surface of the cured tread may optionally be primed to optimize reception of the dried cement composition. Various different types of priming treatment may be employed, and the invention is not limited to any particular priming treatment. Known techniques include treatment of the substrate surface with a halogen-containing priming agent or by oxidation methods; these techniques are disclosed as in U.S. Pat. Nos. 4,390,678 and 5,462,617, which are incorporated herein by reference.

In one or more embodiments, practice of the present invention is not necessarily limited by the techniques employed to apply the dry-transfer cement composite to the cured tread. In one or more embodiments, an indexing machine/applicator could advance the release liner exposing and applying the adhesive to the back side of the tread component. The application of the dry-transfer cement composite could thus be automated such that, as cured treads approach the equipment to supply the adhesive, the release liner is appropriately advanced to apply the dried film layer to the tread component second surface as desired. The release liner remains as part of the tread composite for shipping and distribution to the retreading processing facility.

In other embodiments, the dry-transfer cement composite and the tread are simultaneously rolled on a spindle in manner where the back of the tread contacts the adhesive layer of the dry-transfer cement composite and the hoop stress caused by the movement of the spindle serves to apply force that assists in mating the surfaces.

### Cured Tread Component

In one or more embodiments, practice of the present invention is not necessarily limited by the selection of the cured tread component, which may also be referred to as a pre-cured profiled tread strip or a tread substrate. Accordingly, the step of providing a cured tread for mating with the dry-transfer cement composite may rely on know techniques of the prior art, especially the known art relating to treads adapted for use in retreading operations. As is known in the art, the cured rubber component may advantageously include a tread pattern having varying topographies and/or designs. In one or more embodiments, the cured tread may be formed by methods known to those skilled in the art including, but not limited to, curing with a flat molding press. Cured treads useful in practice of the present invention include those described in U.S. Pat. Nos. 3,951,720, 4,075,047, 4,046,947, and 8,298,463, as well as EP 0989171, which are incorporated herein by reference.

As generally shown in the FIGS. 1 and 2, the cured tread will have a planar surface 16 opposite the lug pattern side 18. The planar surface 16 may be integral with the lug pattern to the extent that both derive from the same extrudate, or in other embodiments planar surface 16 may derive from one or more additional rubber layers mated to the lug pattern. The latter includes build-up treads, which include a strip of cured rubber that does not have any tread pattern thereon and that is designed to provide a thickened surface on the tire casing prior to application of the outer tread, which includes the grooves and/or lugs.

In one or more embodiments, the cured tread may be formed from rubber compounds including a variety of crosslinkable rubbers such as, but not limited to, natural rubber, synthetic polyisoprene, polybutadiene, butadiene-isoprene copolymers, rubbery copolymers of butadiene and styrene, rubbery copolymers of butadiene and acrylonitrile, rubbery copolymers of isoprene and isobutylene, polychloroprene, ethylene-proplylene rubbers, and the like.

As discussed above, application of the dry-transfer cement to the cured tread forms a composite tread assembly. This assembly, which can be manufactured within a tread-manufacturing facility, can then be stored and/or transported to a retreading facility. In one or more embodiments, the composite tread assembly is rolled for storage and shipment.

### Retreading Process

Practice of one or more embodiments of the present invention is not necessarily limited by the retreading process used to ultimately produce a retreaded tire. Accordingly, processes known in the art may be used in the practice of this invention. In this regard, U.S. Pat. Nos. 3,335,041, 3,421,565, 3,342,238, 3,514,423, 4,463,120, 4,539,365, and 8,143,338, are incorporated herein by reference.

In one or more embodiments, the retreading process employed in the practice of this invention includes (a) providing a tire casing; (b) applying a cushion gum to the casing, (c) removing the release liner from the tread composite to expose the dried film; (d) adhering the dried film of the tread composite to the cushion gum to form an uncured retread composite; and (e) processing the uncured retread composite to cure the cushion gum and thereby form a retread tire.

In one or more embodiments, step (a) of providing a tire casing may include preparing a tire casing with a buffed surface by buffing off the existing tread of the tire. In these or other embodiments, step (b) of applying a cushion gum to the casing further may include applying a layer of unheated cushion gum directly to the buffed surface under tension to stretch the layer of unheated cushion gum to facilitate conformation to the buffed surface and thereafter stitching the layer of unheated cushion gum with sufficient pressure to force air from between the casing and the layer of cushion gum. In one or more embodiments, step (e) of processing uncured retread composite to cure the cushion gum further may include encasing the uncured retread composite in an envelope.

In typical situations, the process begins with an inspection can be made of the tire casing. This may include manual inspection such as visual inspection and tactile inspection. In one or more embodiments, inspection can be performed using the assistance of equipment that can perform non-destructive testing. This equipment may include, for example, X-ray.

In one or more embodiments, cold process retreading is employed wherein a casing is provided by removing tire tread from the tire casing by a buffing machine, such as those machines manufactured by Bridgestone Commercial Solutions. During the buffing operation, the original tire tread is ground away from tire casing, thereby leaving a tire casing with a buffed surface. The buffed surface extends circumferentially about tire casing and also extends transversely across the outside of outer radial wall until it terminates at buffed shoulder areas.

In one or more embodiments, following the buffing step, the casing may be treated (e.g. sprayed) with a cement in order to assist in the subsequent application of a calendered cushion gum. Various cements may be employed and the invention is not limited to any particular cement treatment.

In one or more embodiments, following removal of the used tread layer, the casing may undergo repair. For example, the casing may undergo skiving and filling. Skiving is the removal of damaged material from a tire prior to making a repair. Often, the tire casing accumulates cuts, holes, nicks, or tears due to stones or other sharp objects the tire comes in contact with during use. The injured or damaged area may be first ground smooth by an appropriate grinding tool and then filled with repair gum, which may be done using a an extruder repair rope or repair gum or some other suitable material. It may be necessary to fill the injured areas to the level of buffed surface to avoid air pockets between buffed surface and the later applied tread layer. Trapped air can have negative effects on the longevity of a typical retreaded tire.

In addition to skiving, which primary addresses minor damage including non-penetrating injuries, the repair process may also include section repair where cables or other reinforcing elements of the tire are repaired. Also, repair may be made to penetrating injuries such as may occur by using various plugs and patches to repair punctures in the casing.

In one or more embodiments, the tire casing is allowed to equilibrate at ambient indoor temperature and humidity for a period of time, or in other embodiments from about 10 to 15 hours. In one or more embodiments, visible surface moisture on the casing is removed, and holes or other damage to the casing are repaired.

In one or more embodiments, following the repair operation, a building step occurs in which a layer of cushion gum and a tread composite are wrapped about the circumference of the tire casing along the buffed surface. In one or more embodiments, the tread composite and optionally the cushion gum are applied using a building machine, such as those available from Bridgestone Commercial Solutions.

In one or more embodiments, where the cushion gum is applied in the form of a calendered sheet, the cushion gum and the tread composite can be applied at the same machine. Although the layer of cushion gum could be applied to tire casing in a variety of ways, in one embodiment, a roll of the cushion gum is rotatably mounted on the building machine. The layer of cushion gum moves about a tensioning roller prior to being wrapped circumferentially around buffed surface.

Alternatively, where the cushion gum is applied to the casing in the form of an extrudate extruded from an extruder, the cushion gum may be applied at a first station followed by application of the tread at a second station.

In certain embodiments, the cushion gum layer is covered by a protective film, for example a bottom plastic sheet, e.g. a poly sheet, and a similar top plastic sheet. The bottom sheet may be peeled away from the cushion gum layer shortly before the cushion gum is wrapped about the tire casing along the buffed surface. The bottom plastic sheet may then be wrapped about the tensioning roller.

The cushion gum layer may be applied to the buffed surface within eight hours of buffing. Additionally, the layer of cushion gum may be applied under tension in the circumferential direction. Depending on the application, it may be desirable to slightly stretch the cushion gum layer to achieve better adherence to the buffed surface. Typically, the cushion gum layer is cut transversely, and the cut edge is spliced with the leading edge so there is no gap between the beginning and the end of cushion gum layer.

In one or more embodiments, the cushion gum of the retreading process is applied to the buffed casing within from about 0 or more hours to about 72 or less hours of buffing. In these or other embodiments, the cushion gum is applied to the buffed casing within from about 0 or more hours to about 8 or less hours of buffing.

In one or more embodiments, the cushion may be applied to the tire casing and trimmed to size. The resulting “cushioned” tire casing is then paired with the tread composite of the present invention and subjected to curing, as described later.

Practice of one or more embodiments of the present invention is not necessarily limited by the type of cushion gum employed. Accordingly, known cushion gums may be used in the practice of this invention. In this regard, cushion gums, which may also be referred to as bonding materials, useful in practice of this invention are disclosed as in U.S. Pat. Nos. 4,046,947, 4,075,047, 4,756,782, 5,503,940, and 7,528,181, which are incorporated herein by reference.

After the cushion gum layer is applied to the tire casing, a layer is stitched, or in other words pressed, against buffed surface to drive out any air trapped between the cushion layer and buffed surface of the casing. Following stitching, the top layer of plastic is removed from the cushion gum layer to permit the tread composite of the invention to be applied over the cushion gum. The stitching step also helps prevent the cushion from lifting away from the buffed surface when plastic the protective film is removed and the tread composite is applied.

In one or more embodiments, the tread composite is also applied with the assistance of the building machine, although there are a variety of ways to wrap the tread composite about the circumference of the tire casing. When using the building machine, the tread composite may be guided onto the tire casing against the cushion gum layer by guide rollers.

The tire casing is rotated on the building machine until a sufficient length of tread composite is unraveled from the tread composite roll to extend about the circumference of the tire casing as the release liner is removed upon application. The tread composite is then cut generally transversely to the circumferential direction, and the cut end is butted up against the leading edge of the tread composite to form a splice. The tread composite splice is often held together by a plurality of staples. In one or more embodiments, the spliced area of cushion gum layer and the spliced area of tread composite may be disposed at different points along buffed surface.

In one or more embodiments, after application of cushion gum layer and tread composite, a retreaded tire assembly is formed and ready for curing under appropriate heat and pressure conditions. The overall tire assembly is inserted into a rubberized curing envelope designed for the particular tire type and size being retreaded. The envelope is sealed to the beads of the tire casing.

In one or more embodiments, the tire casing/tread composite assembly is then placed in a curing envelope and subjected to heat to cure the cement composition. The curing temperature is typically within the range of 140°-400° F., or in other embodiments in the range of 210° F.-250° F. (98°-121° C.).

In one or more embodiments, the curing may be carried out under pressure so as to ensure that the tread conforms to the compound outer curvature of the casing. In one or more embodiments, the pressure applied is about 80 PSI to 100 PSI relative to atmospheric, for example 85 to 90 PSI.

The time taken to effect the curing will depend on the curing conditions. Typically, the cure time is about 3 hours when the cure temperature is about 220° F. and the relative pressure is 85 PSI. After the curing process is completed, the heating is stopped and the pressure on the curing envelope is returned to atmospheric.

### EXAMPLES

The following examples are submitted for the purpose of further illustrating the nature of the present invention and are not to be considered as a limitation on the scope thereof. Parts of each ingredient are by weight, unless otherwise specified.

### Example 1

### (a) Dry-Transfer Cement Preparation

Eight cement compositions were prepared and formed into dry-transfer cement layers on release layers. The cement was a commercially available cement obtained from Bridgestone Commercial Solutions (or it predecessor). Two release layers were used. The first was a Kraft paper coated with silicone on both sides (this release layer may be referred to as “paper” herein). The second was a polymeric film, which was believed to include polyethylene and/or polypropylene (this release layer may be referred to as “poly” herein).

A coating machine and associated material rerolling processing equipment were used to prepare the dry-transfer cement. The coating machine included three main sections: (1) the release layer preparation and coating delivery section, (2) the heating/drying oven section, and (3) the wind up section. In the first section, the release layer is aligned, tension applied to the release layer (as necessary, using an air clutch), and a coating applied to the release layer. The thickness of the coating was controlled by “scraping” excess coating off the release layer using one of several wire would rods that span the width of the release layer. The second section of the coater included a two zone variable temperature capability oven with rollers present to support the release layer from underneath. The third wind-up section applied additional tension to the release layer. The wind up rolls supplied force to move the release layer through the machine. The calendar rolls allowed interleaving of a layer of poly between the cement and the silicone release paper. Oven temperature and line speed were varied during the trial to provide acceptable product. Trials are summarized in Table I.

TABLE I

| | Calcu- | | Release | | |
|---|---|---|---|---|---|
| | lated | Actual Cement | Liner: | Oven | |
| Trial | Cement | Coverage | silicone | Temper- | Line |
| Num- | Coverage | Side/Middle/Side | paper or | ature | Speed |
| ber | (mils) | g/in² | poly | ° F. | ft/min |
| 1 | 0.1 | 0.0020/0.0016/0.0019 | Paper | 248 | 13.6 |
| 2 | 0.3 | 0.0028/0.0041/0.0040 | paper | 248 | 13.6 |
| 3 | 0.3 | — | paper/poly | 248 | 13.6 |
| 4 | 0.6 | 0.0073/0.0052/0.0050 | paper | 248 | 10.2 |
| 5 | 0.6 | — | paper/poly | 248 | 10.2 |
| 6 | 0.6 | — | paper | 248 | 68-74 |
| 7 | 0.3 | 0.0028/0.0041/0.0040 | poly | 148 | 11.1 |
| 8 | 0.6 | 0.0073/0.0052/0.0050 | poly | 148 | 11.1 |

Three methods of preparation of the dry-transfer material were attempted during trials including (1) direct coating onto silicone paper, (2) direct coating onto finish line poly, and (3) transfer of dry-transfer cement coating from silicone paper to poly. In the direct coating of cement onto paper or poly release liners, the liners are fed through the coater and the proper thickness control rod is placed in the machine. During the optimized run, no additional tension was applied at the substrate preparation section to the poly during the coating operation.

The thickness of the cement applied to the release materials was that calculated to provide a target film thicknesses of 0.3, 0.6, and 0.9 mils of cement after drying. During the interleaving of poly with silicone paper, a 60 psi pressure was applied to a laminating roller. Upon windup of cement coated poly, a repositioning of the poly as it entered the calendar and just prior to wind up was necessary to produce material that was relatively wrinkle free.

### (b) Tread Composite Preparation & Testing

Dry-transfer cement quality was evaluated by hand stitching 1 by 4 inch strips of dry-transfer material onto freshly buffed D4310™ and Mizer Drive™ tread materials obtained from Bandag, Inc. (now Bridgestone Commercial Solutions). Laboratory trials were conducted either with the dry-transfer cement at room temperature or heated with a hot air gun after their applications to the treads. The step of heating was performed to simulate factory application after buffing. The dry-transfer cement was stitched with a two-inch wide linoleum roller immediately after application to the treads. Strips were removed to evaluate aging on the transfer process at time intervals after application of 0, 1 day, 4 days, 6 days, and 14 days. Transfer of cement to the tread surface was rated on a 1 to 5 scale where:

1-Poor-0-20% coverage
2-Moderate-20-40% coverage
3-Acceptable-40-60% coverage
4-Good-60-80% coverage
5-Excellent-80-100% coverage

Averages are reported in Table II. Substrates that were heated were heated as uniformly as possible prior to stitching using two laboratory 500° F. heat guns.

TABLE II

| | | | | Tread |
|---|---|---|---|---|
| | | Substrate/ | | Coverage |
| | Roll | Coverage | | Rating |
| Tread type | ID # | (mils) | Heated? | (Avg) |
| Mizer Drive | 1 | Silicone/0.1 | No | 1.8 |
| | 2 | Poly/0.6 | | 1.6 |
| | 3 | Poly/0.3 | | 1.8 |
| | 4 | Silicone/0.6 | | 1.4 |
| | 5 | Silicone/0.3 | | 1.5 |
| D4310 | 1 | Silicone/0.1 | | 1.7 |
| | 2 | Poly/0.6 | | 4.9 |
| | 3 | Poly/0.3 | | 4.7 |
| | 4 | Silicone/0.6 | | 1.5 |
| | 5 | Silicone/0.3 | | 3.3 |
| Mizer Drive | 1 | Silicone/0.1 | Yes | 4.4 |
| | 2 | Poly/0.6 | | 3.2 |
| | 3 | Poly/0.3 | | 2.4 |
| | 4 | Silicone/0.6 | | 3.9 |
| | 5 | Silicone/0.3 | | 4.6 |
| D4310 | 1 | Silicone/0.1 | | 3.4 |
| | 2 | Poly/0.6 | | 4.5 |
| | 3 | Poly/0.3 | | 4.5 |
| | 4 | Silicone/0.6 | | 3.9 |
| | 5 | Silicone/0.3 | | 4.3 |

For preparation of the treads, an applicator pressure of 100 psi was used. In the preparation of treads using unheated silicone transfer material and all of the poly transfer materials, the materials were mated with the treads and run through the stitcher in a near continuous fashion. In the preparation of material using heated silicon substrate, the feed of material through the stitcher was non continuous, with the feed stopped enough to allow heating of the substrate just prior to stitching.

Candidates from Table II were selected for further analysis. Treads were prepared according to Table III in the order indicated by tread identification number, wherein the silicone release liner tread composites were prepared first, followed by preparation of the treads using the poly dry-transfer cement laminates. Tack ratings are presented in Table III, wherein 1 is the least tack and 10 is greatest tack. The data in Table III shows the effect of the dry-transfer cement on the preparation and application on tack.

TABLE III

| | | Substrate/ | | | Tack |
|---|---|---|---|---|---|
| | Roll | Coverage | | Tread | Rating |
| Tread type | ID # | (mils) | Heated? | ID # | (1 to 10) |
| Mizer Drive | 1 | Silicone/0.1 | No | 3 | 1 |
| | 3 | Poly/0.3 | | 5 | 6 |
| | 2 | Poly/0.6 | Yes | 9 | 9 |
| | 5 | Silicone/0.3 | | 1 | 1 |
| D4310 | 2 | Poly/0.6 | No | 6 | 5 |
| | 3 | Poly/0.3 | | 8 | 5 |
| | 5 | Silicone/0.3 | | 2 | 1 |
| | 3 | Poly/0.3 | Yes | 7 | 8 |
| | 4 | Silicone/0.6 | | 4 | 1 |

In all cases of tread preparation using the silicone substrate, adequate contact could not be maintained resulting in loosened transfer material from the treads and scoring a rating of 1 on Table III.

Trials using the poly as release liner resulted in greater tack. The “goodness” of contact was rated as the number of “wrinkles” per length of tread. As the material was fed through the roller, the dry-transfer cement appeared to be fed through the roller faster due to contact with the drive roller as with the silicone paper dry-transfer material. Contact between the poly dry-transfer material and tread due to the formation of wrinkles in the poly. The more wrinkles present per unit length, the smaller the distance between areas of non contact. The application of dry-transfer cement/poly laminate onto the treads was best with heated substrate.

### (c) Tire Building

The treads used were standard D4310 or Mizer Drive, received and stored unbuffed. All treads were buffed and the dry-transfer cement applied immediately after buffing. On the day of building, treads had aged 13 days with the dry-transfer cement in contact with the buffed surface of the treads.

Tire casings used to prepare the test tires were R1 Bridgestone R 194 285/75R24.5's. The tire casings were allowed to equilibrate at shop temperature and humidity for at least 12 hours before beginning tire retreading. The tires were buffed to predetermined undertread depth and buffing radius according to predetermined specifications. The casing circumference was then measured to the nearest ¼ inch. Cushion gum was applied to the exterior surface of the tire casing.

The tread composite was placed on the casing/cushion gum and the two surfaces mated. The ends of the splice were mated together and stapled together with setting staples every ½ inch. The tire was then rotated on builder, and a polymer film wrapped around the surface of the tread as the tire rotated in order to keep the tread in proper orientation during the enveloping process. The free end of the film was then stapled onto the surface of the tire through the area containing the setting staples. A perforated tube was placed around the tire to facilitate air evacuation during curing.

The curing envelope containing the tire was then placed in a heating and pressure chamber, and the curing envelope connected to the exhaust line of the chamber. The chamber pressure is then increased to a relative pressure of about 85 PSI. When the pressure in the chamber reaches about 70 PSI, the pressure in the envelope was increased from atmospheric pressure to, for example, about 70 PSI. In this way, pressure was applied to regions at the bottom of the tread grooves to ensure complete adhesion of the tread surface to the tire casing. The air pressure was applied interiorly of the envelope throughout the curing process. The curing is carried out at 210° to 250° F. and a relative pressure of 85 PSI for approximately 4 hours.

When the curing process was completed, the envelope was removed from the curing chamber, and the tire removed from the curing envelope. The wick and the perforated tube and the polymer film were then removed and the tire examined to ensure that no edge-lifting or tread shifting has occurred.

The treads were successfully used to build tires. The tires were subjected to testing and the results are shown in Table IV. The transfer of cement onto the buffed surfaces under the void and rib areas was acceptable as indicated by the transfer ratings. The transfer to the underside of the lugs was sporadic with ratings as indicated in Table IV. Road wheel testing indicated that all of these treatments produced treads having adequate adhesion based upon the number of road wheel hours.

TABLE IV

| Substrate/ | | | | | Road |
|---|---|---|---|---|---|
| Coverage | | | | | Wheel |
| (mils)/ | Tread | Tire | | Transfer | Hours |
| Heated? | ID # | Building | Build Comments | Rating | Completed |
| Silicone/0.3/Yes | 1 | 2^{nd} OK | 1^{st} attempt failed - | 3.7 | 47 |
| | | | discarded 10 feet | | |
| | | | of tread before | | |
| | | | 2^{nd} attempt | | |
| Poly/0.3/Yes | 7 | OK | None | 5.0 | 47 |
| Poly/0.6/No | 6 | Poor | Poor tack between | 3.7 | 47 |
| | | | cushion and tread | | |
| Silicone/0.3/No | 8 | OK | None | 3.7 | 47 |
| Silicone/0.1/No | 3 | OK | Skives in tire - | 5.0 | 47 |
| | | | new cushion roll | | |
| Poly/0.6/Yes | 9 | OK | None | 3.3 | 47 |
| Silicone/0.6/Yes | 4 | OK | None | 4.0 | 47 |
| Silicone/0.3/No | 2 | OK | Good transfer of | 3.0 | 47 |
| | | | cement to bottom | | |
| | | | of lugs | | |
| Poly/0.3/No | 5 | OK | Moderate transfer | 5.0 | 47 |
| | | | of cement to | | |
| | | | bottom of lugs | | |

In the transfer of cement, substantially all of the cement was removed from the release liner. Where the transfer was considered good, the cement remained in contact with the tread on separation of the cement from the dry-transfer release material. Where the transfer was considered poor, part of the cement layer separated from the tread and remained in contact with the release liner.

What is claimed is:

1. A process for retreading a tire, the process comprising the steps of:
(i) providing a liquid rubber cement composition including a solvent;
(ii) providing a release liner;
(iii) applying the liquid cement composition to the release liner to form a wet film on said release liner;
(iv) allowing the solvent to evaporate to thereby convert the wet film to a dried film on the release liner and thereby form a dry-transfer cement composite;
(v) providing a cured rubber component having first and second planar surfaces, where the first planar surface includes a tread pattern;
(vi) adhering the dried film to the second planar surface of the cured rubber component to thereby form a tread composite; and
(vii) preparing a retreaded tire using the tread composite.

2. The process of claim 1, where step (vii) further comprises the steps of (a) providing a tire casing; (b) applying a cushion gum to the casing, (c) removing the release liner from the tread composite to expose the dried film; (d) adhering the dried film of the tread composite to the cushion gum to form an uncured tread composite; and (e) processing the uncured tread composite to cure the cushion gum and thereby form a retread tire.

3. The process of claim 2, where step (a) of providing a tire casing further comprises preparing a tire casing with a buffed surface by buffing off the existing tread of the tire.

4. The process of claim 3, where step (b) of applying a cushion gum to the casing further comprises applying a layer of unheated cushion gum directly to the buffed surface under tension to stretch the layer of unheated cushion gum to facilitate conformation to the buffed surface and thereafter stitching the layer of unheated cushion gum with sufficient pressure to force air from between the casing and the layer of cushion gum.

5. The process of claim 4, where the step (e) of processing the uncured tread composite to cure the cushion gum further comprises encasing the uncured tread composite in an envelope.

6. The process of claim 1, where the release liner is a polymeric film.

7. The process of claim 1, where the liquid rubber cement includes a crosslinkable polymer, a tackifier, and a curative.

8. The process of claim 1, where the cushion gum is applied to the buffed casing in the form of an extrudate extruded from an extruder.

9. The process of claim 1, further comprising the step of capturing the solvent that is evaporated.

10. The process of claim 1, where the cement includes natural rubber.

11. A process for producing a dry-transfer cement adapted for application to the backside of a cured tread, the process comprising the steps of:
(i) providing a liquid rubber cement composition including a solvent;
(ii) providing a release liner;
(iii) applying the liquid cement composition to the release liner to form a wet film on said release liner; and
(iv) allowing the solvent to evaporate to thereby convert the wet film to a dried film on the release liner and thereby form a dry-transfer cement composite.

12. The process of claim 11, where the rubber cement includes a crosslinkable rubber, a tackifier, and a curative.

13. The process of claim 12, where the release liner is a polymeric film.

14. A process for producing a tread composite adapted for use in retreading a tire, the process comprising the steps of:
(i) providing a liquid rubber cement composition including a solvent;
(ii) providing a release liner;
(iii) applying the liquid cement composition to the release liner to form a wet film on said release liner;
(iv) allowing the solvent to evaporate to thereby convert the wet film to a dried film on the release liner and thereby form a dry-transfer cement composite;
(v) providing a cured rubber component having first and second planar surfaces, where the first planar surface includes a tread pattern; and
(vi) adhering the dried film to the second planar surface of the cured rubber component to thereby form a tread composite.

15. The process of claim 14, where the cement includes a crosslinkable rubber, a tackifier, and curative, and the where the release liner is a polymeric film.

16. A dry-transfer cement composite comprising:
a first layer including a pressure sensitive adhesive composition including a rubber, a tackifier, and a curative, based upon the entire weight of the adhesive composition; and
a release liner removably adhered to the first layer.

17. The dry-transfer cement composite of claim 16, where the composite is adapted to be secured to the backside of a cured tread.
